(19) United States
(12) Patent Application Publication
(10) Pub. No.: US 2009/0116252 A1
(43) Pub. Date: May 7, 2009

(54) THERMAL SURFACE MOUNTING OF MULTIPLE LEDS ONTO A HEATSINK

(75) Inventors: Eric J. Kille, Mundelein, IL (US); Ron Steen, Grayslake, IL (US); Ernie Combs, Raleigh, NC (US); Timothy B. Moss, Chicago, IL (US); Bernd Clauberg, Schaumburg, IL (US)

Correspondence Address: PHILIPS INTELLECTUAL PROPERTY & STANDARDS, 3 BURLINGTON WOODS DRIVE, BURLINGTON, MA, 01803, US

(73) Assignee: KONINKLIJKE PHILIPS ELECTRONICS N V, Eindhoven (NL)

(21) Appl. No.: 12/299,812

(22) PCT Filed: Apr. 6, 2007
(86) PCT No.: PCT/IB07/51255

§ 371 Date: Nov. 6, 2008

Related U.S. Application Data
(60) Provisional application No. 60/746,656, filed on May 8, 2006.

(51) Int. Cl. F21V 29/00

(52) U.S. Cl. 362/373

(57) ABSTRACT

A LED package employs a heatsink (30), a LED (10) thermally mounted to the heatsink (30), and a printed circuit board (20) including a hole (21) extending there through for facilitating the thermal surface mounting of the LED (10) onto the heatsink (30). The printed circuit board (20) is preferably surface mounted onto the heatsink (30). The LED (10) is seated within the hole (21) and includes leads (11, 12) electrically coupled to the printed circuit board (10) wherein a portion of each lead (11, 12) is partially seated within the hole (21), and/or the heatsink (30) includes a post (31) seated within the hole (21) and the LED is thermally mounted to the post (31).

The present invention generally relates to a thermal management of a light emitting diode (“LED”) package. The present invention specifically relates to a thermal surface mounting of multiple LEDs onto a heatsink.

One current thermal management technique for packaging multiple LEDs is to use a metal core printed circuit board (“PCB”). An aluminum substrate of the metal core PCB provides thermal contact to keep the LEDs in an appropriate operating temperature range. At the same time, a dielectric layer on the metal core PCB provides electrical isolation for the body of the LEDs. Leads off of the LEDs are soldered to pads on the top layer of the metal PCB to electrically connect each LED to the circuit. The metal core PCB with the LEDs attached is then mounted to a heatsink to complete the thermal management of the LEDs.

Another current thermal management technique for packaging multiple LEDs is to directly mount a single LED to heat spreader through a hole in a PCB. The leads of the LED are bent and soldered to the PCB to make the circuit. The heat spreader is then directly mounted to a heatsink to complete the thermal management of the LED.

The present invention provides a new and unique thermal management technique for packaging multiple LEDs encompassing a LED package comprising a heatsink, a printed circuit board, and a LED thermally mounted onto the heatsink. The printed circuit board includes a hole extending there through for facilitating the thermal surface mounting of the LED onto the heatsink.

In a first form of the present invention, the printed circuit board is surface mounted onto the heatsink.

In a second form of the present invention, the LED is seated within the hole and includes leads electrically coupled to the printed circuit board wherein a portion of each lead is partially seated within the hole.

In a third form of the present invention, the heatsink includes a post seated within the hole and the LED is thermally mounted to the post.

The foregoing forms and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

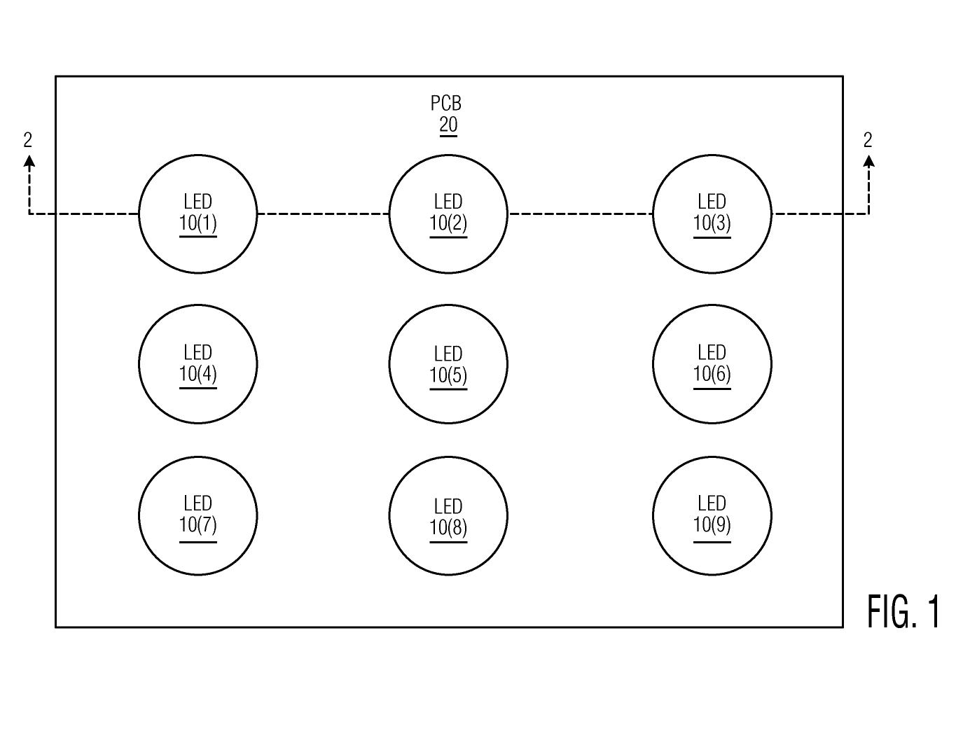

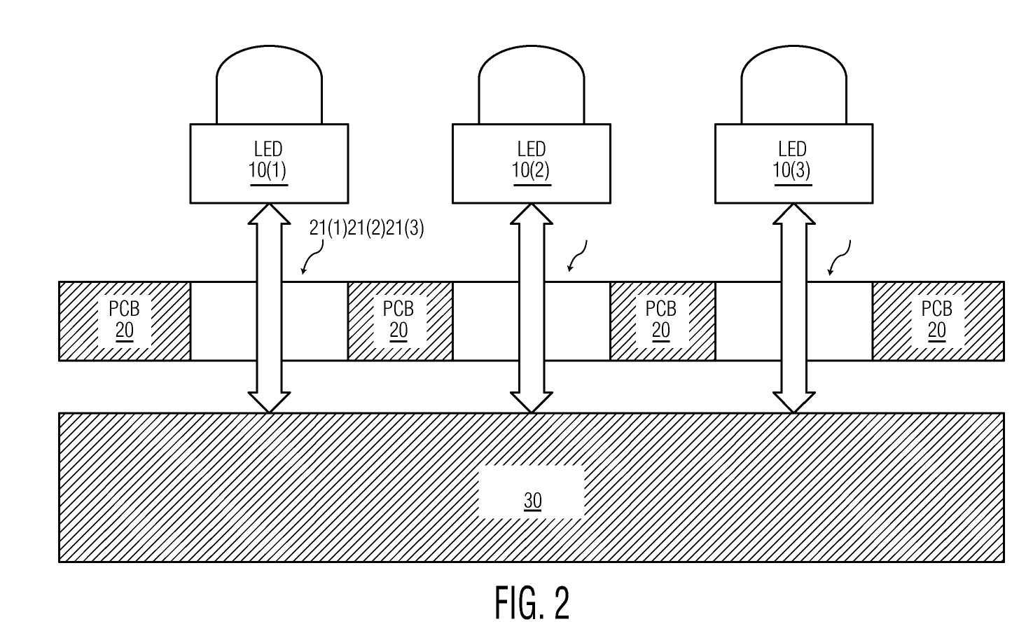

FIGS. 1 and 2 illustrate a top view and a cross-sectional side view, respectively, of a base embodiment of a multiple LED package in accordance with the present invention;

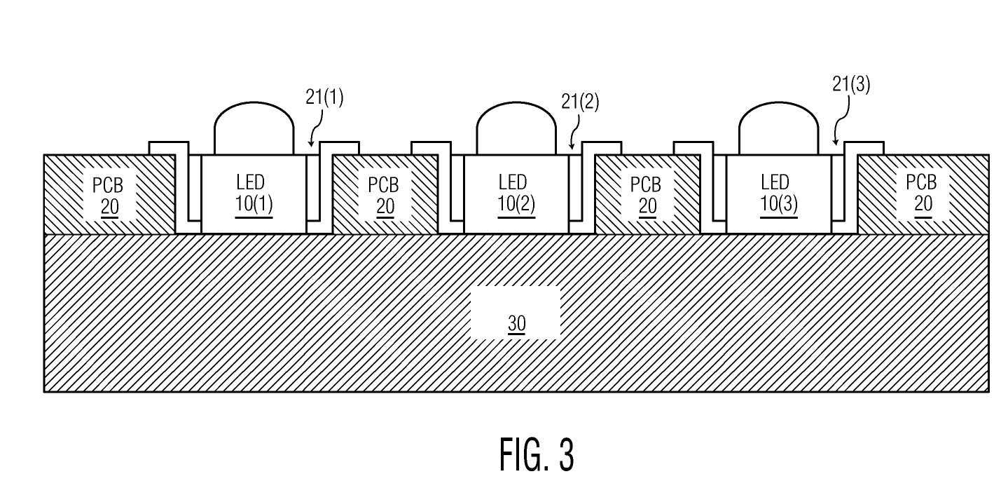

FIG. 3 illustrates a cross-sectional side view of a first exemplary embodiment of the multiple LED package illustrated in FIGS. 1 and 2 in accordance with the present invention;

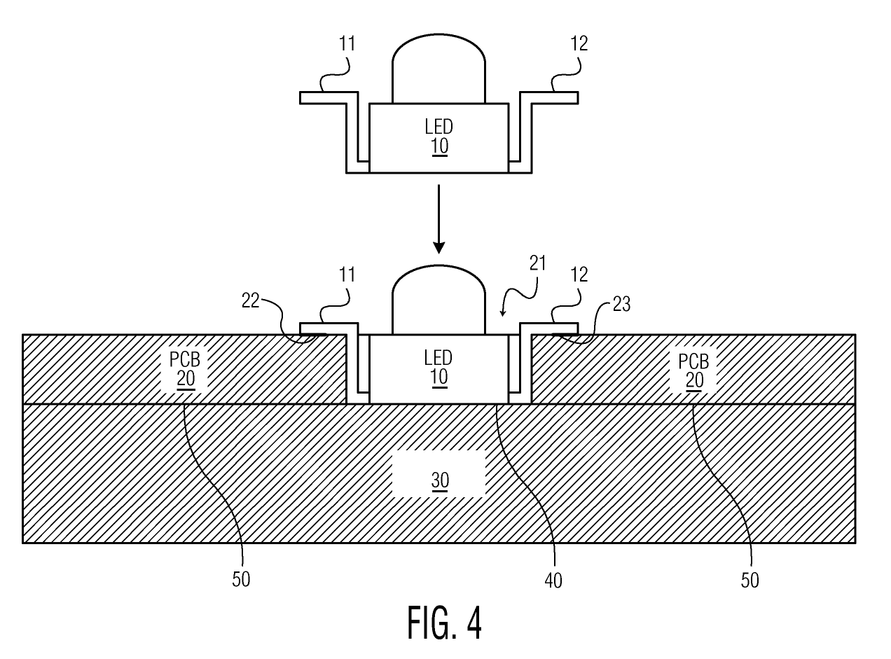

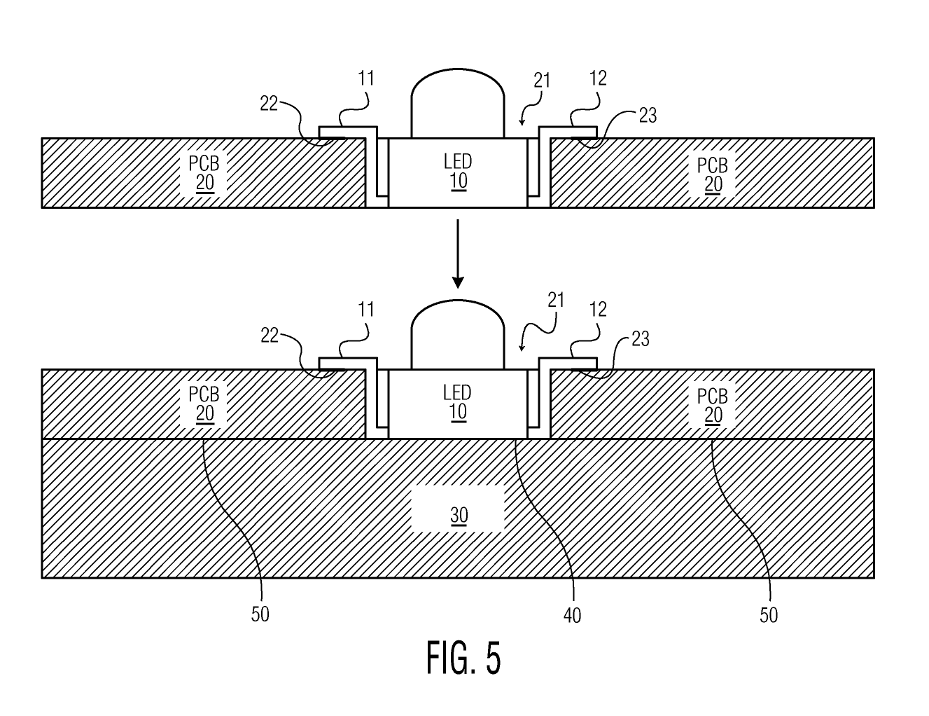

FIGS. 4 and 5 illustrate cross-sectional side views of exemplary thermal surface mountings of a LED onto a heatsink as illustrated in FIG. 3;

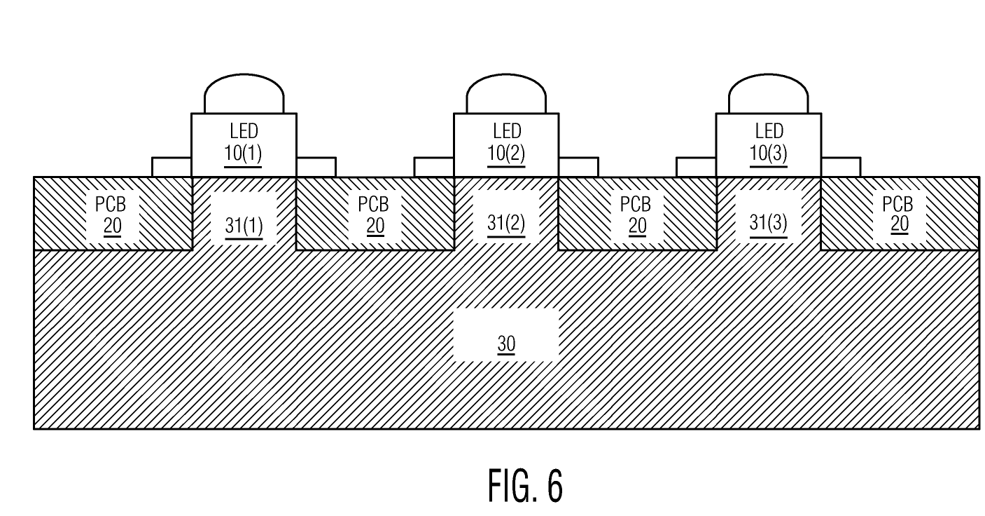

FIG. 6 illustrates a cross-sectional side view of a second exemplary embodiment of the multiple LED package illustrated in FIGS. 1 and 2 in accordance with the present invention; and

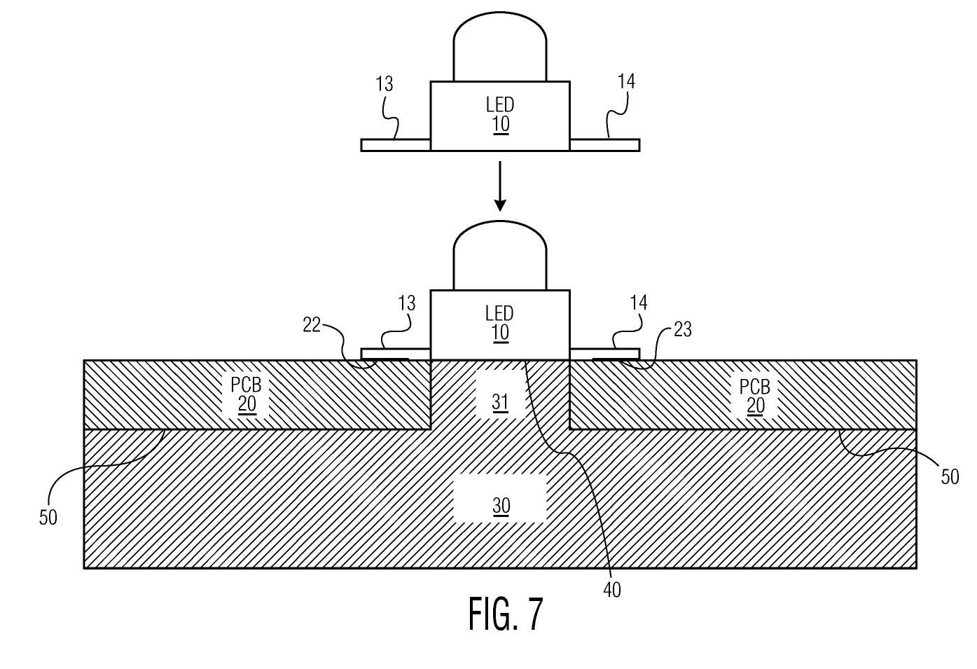

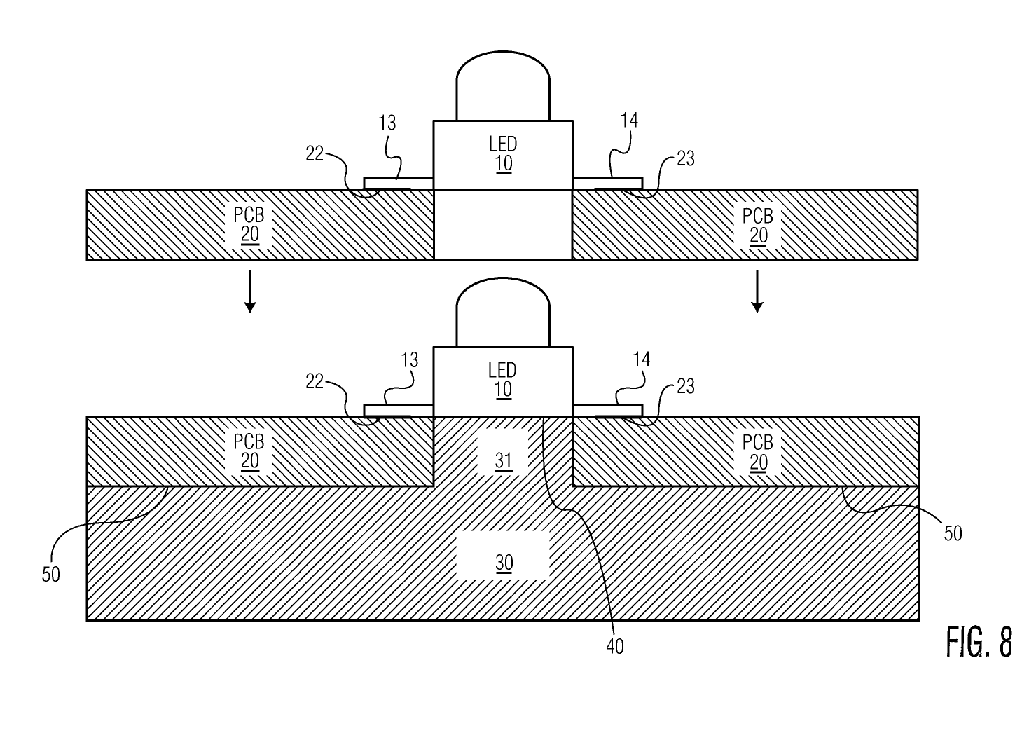

FIGS. 7 and 8 illustrate a cross-sectional side views of an exemplary thermal surface mountings of a LED onto a heatsink as illustrated in FIG. 6.

A multiple LED package of the present invention as illustrated in FIGS. 1 and 2 employs nine (9) LEDs 10 of any type, a printed circuit board (“PCB”) 20 of any type and a heatsink 30 of any type. As best shown in FIG. 2, PCB 20 includes a hole 21 for each LED 10 for facilitating a thermal surface mounting of each LED 10 to heatsink 30. For purposes of the present invention, the term “thermal surface mounting” of a LED 10 to heatsink 30 is broadly defined herein as a thermal coupling of a surface of a LED 10 to a surface of heatsink 30. To attain the thermal surface mounting of the LED 10 to heatsink 30, either LED 10 is seated, partially or entirely, within a corresponding hole 21 of PCB 20 and/or an underlying portion of heatsink 30 is seated, partially or entirely, within the corresponding hole 21 of PCB 20.

To facilitate a further understanding of the present invention, exemplary embodiments of the multiple LED package of FIG. 1 will now be described herein in connection with FIGS. 3-8.

FIG. 3 illustrates three (3) LEDS 10 seated within respective holes 21 of PCB 20.

In one embodiment, as best shown in FIG. 4, PCB 20 is a non-metallic PCB that is surface mounted by any technique to heatsink 30, which is coated with an electrically isolating coating 50. Thereafter, each LED 10 is seated within a respective hole 21 of PCB 20 whereby a thermally conductive, electrically isolating adhesive 40 thermal couples each LED 10 to heatsink 30. The surface mounting of PCB 20 to heatsink 30 and the thermal surface mounting of each LED 10 to heatsink 30 is coplanar. Additionally, leads 11 and 12 of each LED 10 are physically constructed with two (2) bends to extend out of hole 21 to facilitate an electrical coupling of leads 11 and 12 to respective traces 22 and 23 of PCB 20.

In a second embodiment, as best shown in FIG. 5, each LED 10 is first seated within a respective hole 21 of PCB 20 with leads 11 and 12 of each LED 10 again being physically constructed with two (2) bends to extend out of hole 21 to facilitate an electrical coupling of leads 11 and 12 to respective traces 22 and 23 of PCB 20. Thereafter, PCB 20 in the form of a non-metallic PCB is surface mounted by any technique to heatsink 30, which is coated with an electrically isolating coating 50, while simultaneously each LED 10 is thermally coupled by a thermally conductive, electrically isolating adhesive 40 to heatsink 30. Again, the surface mounting of PCB 20 to heatsink 30 and the thermal surface mounting of each LED 10 to heatsink 30 is coplanar.

FIG. 6 illustrates three (3) posts 31 of heatsink 30 seated within respective holes 21 of PCB 20.

In one embodiment, as best shown in FIG. 7, PCB 20 is a non-metallic PCB that is surface mounted by any technique to heatsink 30, which is coated with an electrically isolating coating 50, in a manner that seats each post 31 within a respective hole 21. Thereafter, each LED 10 is thermally coupled by thermally conductive, electrically isolating adhesive 40 to a respective post 31 of heatsink 30. Additionally, leads 13 and 14 of each LED 10 are electrically coupled to respective traces 22 and 23 of PCB 20 with the electrical coupling of leads 13 and 14 to respective traces 22 and 23 being coplanar to the thermal surface mounting of each LED 10 to a respective post 31 of heatsink 30.

In a second embodiment, as best shown in FIG. 8, leads 13 and 14 of each LED 10 is first electrically coupled to respective traces 22 and 23 of PCB 20. Thereafter, PCB 20 in the form of a non-metallic PCB in a manner that seats each post 31 within a respective hole 21 and thermally surface mounts each LED 10 to a respective post 31 of heatsink 30 via a thermally conductive, electrically isolating adhesive 40. Again, the electrical coupling of leads 13 and 14 to respective traces 22 and 23 is coplanar to the thermal surface mounting of each LED 10 to a respective post 31 of heatsink 30.

Referring to FIGS. 3-8, the two multiple LED packages as shown feature heatsink 30 being coated with coating 50 and each LED 10 being thermally coupled by adhesive 40 to heatsink 30. One alternative version of these multiple LED packages includes coating 50 being omitted in view of the electrically isolating characteristic of adhesive 40. Another alternative version of these multiple LED packages includes adhesive 40 excluding its electrically isolating characteristic in view of the electrically isolating characteristic of coating 50.

Referring to FIGS. 1-8, those having ordinary skill in the art will appreciate numerous advantages of the present invention including, but not limited to, a cost effective and improved thermal management of a LED package in any type of lighting application.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

1. A LED package, comprising:
a heatsink;
a LED thermally mounted to the heatsink; and
a printed circuit board surface mounted to the heatsink,
wherein the printed circuit board defines a hole extending therethrough for facilitating the thermal surface mounting of the LED onto the heatsink.

2. The LED package of claim 1, further comprising:
a thermally conductive adhesive thermally coupling the LED to the heatsink to thereby thermally mount the LED to the heatsink.

3. The LED package of claim 1, wherein the heatsink is coated with an electrically isolating coating.

4. The LED package of claim 1, wherein the LED is at least partially seated within the hole.

5. The LED package of claim 4, wherein the surface mounting of the printed circuit board to the heatsink and the thermal surface mounting of the LED to the heatsink are coplanar.

6. The LED package of claim 4,
wherein the LED includes at least one lead electrically coupled to the printed circuit board, and
wherein a portion of each lead is seated within the hole.

7. The LED package of claim 1,
wherein the heatsink includes a post at least partially seated within the hole; and
wherein the LED is thermally mounted to the post.

8. The LED package of claim 7, further comprising:
a thermally conductive adhesive thermally coupling the LED to the post to thereby thermally mount the LED to the heatsink.

9. The LED package of claim 7,
wherein the LED is electrically coupled to the printed circuit board; and
wherein the electrical coupling of the LED to the printed circuit board and the thermal surface mounting of the LED to the post are coplanar.

10. The LED package of claim 1, wherein the printed circuit board is a non-metallic printed circuit board.

11. A LED package, comprising:
a heatsink;
a LED thermally mounted to the heatsink; and
a printed circuit board defining a hole extending therethrough for facilitating the thermal surface mounting of the LED onto the heatsink,
wherein the LED is at least partially seated within the hole,
wherein the LED includes at least one lead electrically coupled to the printed circuit board, and
wherein a portion of each lead is seated within the hole.

12. The LED package of claim 11, further comprising:
a thermally conductive adhesive thermally coupling the LED to the heatsink to thereby thermally mount the LED to the heatsink.

13. The LED package of claim 11, wherein the heatsink is coated with an electrically isolating coating.

14. The LED package of claim 11,
wherein the printed circuit board is surface mounted to the heatsink, and
wherein the surface mounting of the printed circuit board to the heatsink and the thermal surface mounting of the LED to the heatsink are coplanar.

15. The LED package of claim 11, wherein the printed circuit board is a non-metallic printed circuit board.

16. A LED package, comprising:
a heatsink;
a LED; and
a printed circuit board defining a hole extending therethrough for facilitating the thermal surface mounting of the LED onto the heatsink,
wherein the heatsink includes a post at least partially seated within the hole; and
wherein the LED is thermally mounted to the post.

17. The LED package of claim 16, further comprising:
a thermally conductive adhesive thermally coupling the LED to the post to thereby thermally mount the LED to the post.

18. The LED package of claim 16,
wherein the LED is electrically coupled to the printed circuit board; and
wherein the electrical coupling of the LED to the printed circuit board and the thermal surface mounting of the LED to the post are coplanar.

19. The LED package of claim 16, wherein the heatsink is coated with an electrically isolating coating.

20. The LED package of claim 16, wherein the printed circuit board is a non-metallic printed circuit board.
